(19) United States
(12) Patent Application Publication
(10) Pub. No.: US 2019/0342458 A1
(43) Pub. Date: Nov. 7, 2019

(54) IMAGE FORMING APPARATUS

(71) Applicant: KONICA MINOLTA, INC., Tokyo (JP)

(72) Inventor: Hiroshi SHIMURA, Tokyo (JP)

(73) Assignee: KONICA MINOLTA, INC., Tokyo (JP)

(21) Appl. No.: 16/376,812

(22) Filed: Apr. 5, 2019

(30) Foreign Application Priority Data
May 1, 2018 (JP) 2018-088020

(51) Int. Cl. H04N 1/00

(52) U.S. Cl. CPC H04N 1/0009; H04N 1/00013; H04N 1/00411; H04N 1/00814; H04N 1/00047

(57) ABSTRACT

An image forming apparatus includes: an image forming part that forms an image on a recording material; a reader that optically reads the recording material output from the image forming part; and a hardware processor that stores a proper image, compares the image obtained by optically reading the recording material and the proper image stored with each other to inspect normality/abnormality of an output product, and controls execution of a proper image group creation function including: forming an image of each of pages related to a print job on a recording material by the image forming part; optically reading, by the reader, the recording material output from the image forming part; and storing the image of each of the pages, and execution of a replacement function of replacing a proper image, wherein the hardware processor guides a user to the replacement function after executing the proper image group creation function.

The entire disclosure of Japanese patent Application No. 2018-088020, filed on May 1, 2018, is incorporated herein by reference in its entirety.

### BACKGROUND

### Technological Field

The present invention relates to an image forming apparatus having a function of comparing an image obtained by optically reading a recording material including an image with a proper image, thereby detecting an abnormality in an output product.

### Description of the Related Art

Normally, when a large amount of printing is to be performed, test printing and various adjustments are performed, and main printing is started after confirmation by sample printing that there is no problem in the printout. However, there are cases where an output product of main printing includes stain or color misregistration or distortion with respect to the sample due to some cause. Accordingly, in recent years, each of printed recording sheets is optically read by a scanner on a conveyance path, and then, the scanned image and a previously prepared proper image are compared with each other to detect abnormality of the output product.

The proper image is obtained by optically reading each of recording sheets to be printed by the scanner on the conveyance path when the user performs proof printing such as sample printing and proof output. The obtained proper image is then stored in a storage. A proper image is created on a print job basis. In a case where a print job forms one set including a plurality of pages, the proper image is stored as a proper image group including a plurality of pages forming one set (for example, integrated into one file).

JP 2014-146859 A discloses a technique of preliminarily storing a print job and a proper image of the print job in association with each other and utilizing the proper image associated with the print job when reprinting of the print job is performed.

During proof printing of creating a proper image group, a user visually checks whether there is any abnormality in the output product, and in a case where an abnormality is found or in a case where confirmation cannot be made in time, the user presses a stop button to interrupt the proof printing. In such a case, countermeasures in the conventional image forming apparatus for this problem were limited to selecting either to cancel proof printing or to resume and continue the proof printing. In another case where abnormality is found in the output product of a portion of pages after completion of proof printing for all the pages, there has only been a way to re-output all the pages and recreate a proper image group from the beginning.

In this manner, the conventional technique had to recreate the proper image of all pages even in a case where an abnormality was included in a portion of the pages in the proper image group, leading to poor work efficiency in creating the proper image group.

### SUMMARY

The present invention is presented to solve the above problem and aims to provide an image forming apparatus capable of generating a correct proper image group including all normal pages while suppressing a succeeding work amount after discovery of an abnormality in a case where the abnormality is included in a portion of the proper image group.

To achieve the abovementioned object, according to an aspect of the present invention, an image forming apparatus reflecting one aspect of the present invention comprises: an image forming part that forms an image on a recording material; a reader that optically reads the recording material output from the image forming part; and a hardware processor that stores a proper image, compares the image obtained by optically reading the recording material by using the reader and the proper image stored with each other to inspect normality/abnormality of an output product, and controls execution of a proper image group creation function including: forming an image of each of pages related to a print job on a recording material by the image forming part; optically reading, by the reader, the recording material output from the image forming part; and storing the image of each of the pages obtained by the reading as a proper image group related to the print job, and execution of a replacement function of replacing a proper image of a portion of pages included in the proper image group, wherein the hardware processor guides a user to the replacement function after executing the proper image group creation function.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating a schematic configuration of an image forming apparatus according to an embodiment of the present invention;

FIG. 2 is a view illustrating an example of an internal configuration of an inline scanner unit;

FIG. 3 is a view illustrating an example in which a proper image of a portion (third page) of a proper image group created by confirmation printing is replaced by replacement printing;

FIG. 4 is a view illustrating an example of a first guidance screen displayed on an operation panel in a case where the confirmation printing is interrupted;

FIG. 5 is a view illustrating an example of a replacement page designation screen;

FIG. 6 is a view illustrating an example of a second guidance screen displayed on the operation panel in a case where the confirmation printing is completed up to the final page; and

FIG. 7 is a flowchart illustrating processing performed by an image forming apparatus after confirmation printing is started.

### DETAILED DESCRIPTION OF EMBODIMENTS

Hereinafter, one or more embodiments of the present invention will be described with reference to the drawings. However, the scope of the invention is not limited to the disclosed embodiments.

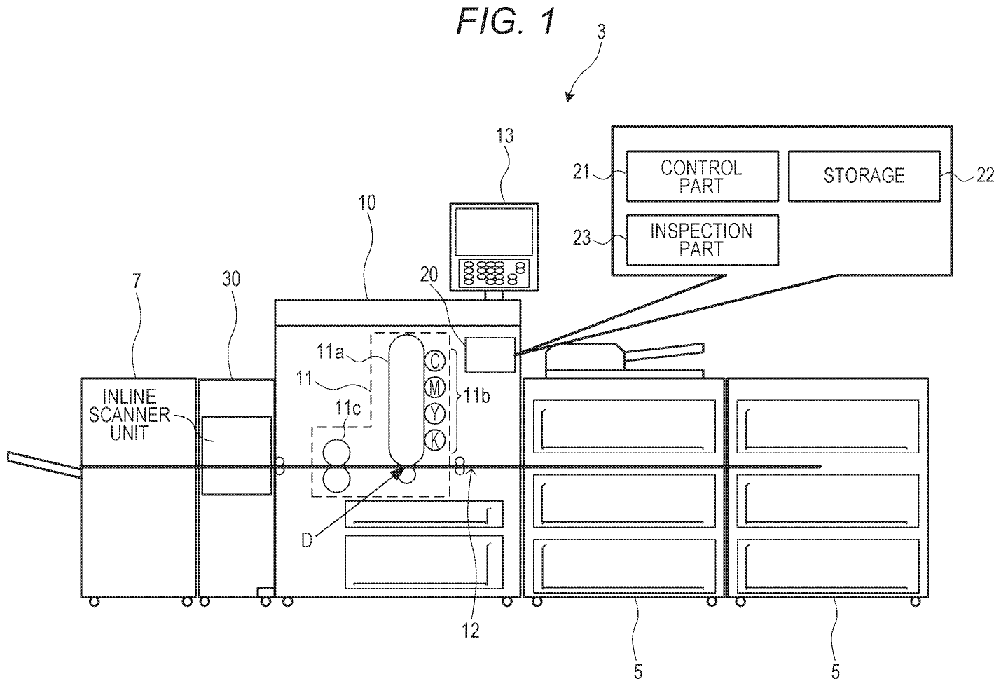

FIG. 1 is a view illustrating a schematic configuration of an image forming apparatus 3 according to an embodiment of the present invention. The image forming apparatus 3 includes a plurality of sheet feed units 5, an image forming apparatus main body 10, an inline scanner unit 30 connected on a downstream side of the image forming apparatus main body 10, and a stacker unit 7 connected on a downstream side of the inline scanner unit 30.

The sheet feed unit 5 includes a plurality of sheet feed trays for storing recording materials (hereinafter referred to as recording sheets) such as recording paper, film, or cloth. The sheet feed unit 5 feeds the recording sheet stored in each of the sheet feed trays to be conveyed toward the image forming apparatus main body 10.

The image forming apparatus main body 10 forms an image on the recording sheet conveyed from the sheet feed unit 5 and sends out the recording sheet to the inline scanner unit 30 on the downstream side.

The inline scanner unit 30 conveys the conveyed recording sheet toward the stacker unit 7 on the downstream side, and together with this, the inline scanner unit 30 optically reads the recording sheet being conveyed and obtains an image.

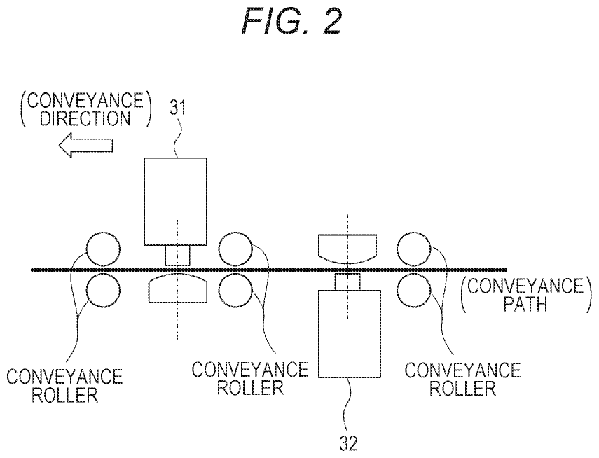

FIG. 2 illustrates an example of an internal configuration of the inline scanner unit 30. In order to achieve one-pass reading of both sides of a recording sheet, the inline scanner unit 30 includes an upper-side line image sensor 31 for reading the front side of the recording sheet and a lower-side line image sensor 32 for reading the back side of the recording sheet.

Returning to FIG. 1, the description will be continued. The stacker unit 7 includes a function of stacking and holding a large number of recording sheets conveyed from the inline scanner unit 30. Note that a post-processing unit that performs post-processing such as folding, binding, and drilling may be connected between the inline scanner unit 30 and the stacker unit 7.

The image forming apparatus main body 10 includes: a conveying part 12 that conveys the recording sheet coming from the sheet feed unit 5; and an image forming part 11 that forms an image on the recording sheet conveyed by the conveying part 12. The conveying part 12 includes a number of conveyance rollers constituting a conveying path, conveyance guides, and motors driven by conveyance rollers. The image forming part 11 includes: an intermediate transfer belt 11a looped endlessly in an annular shape; image forming units 11b of individual colors of C, M, Y, and K arranged along the intermediate transfer belt 11a; and a fixing device 11c.

The image forming apparatus main body 10 causes the image forming unit 11b to superimpose toner images of individual colors of C, M, Y, and K onto the intermediate transfer belt 11a to form a full color toner image. The toner image formed on the intermediate transfer belt 11a is transferred to the recording sheet conveyed from the sheet feed unit 5 at a secondary transfer position D. The recording sheet to which the toner image has been transferred is pressurized and heated during passage through the fixing device 11c on the downstream side, thereby fixing the toner image on the recording sheet. The recording sheet discharged from the fixing device 11c is conveyed by the conveying part 12 toward the inline scanner unit 30 on the downstream side. Note that the image forming part 11 of the image forming apparatus main body 10 is not limited to the tandem type electrophotographic system as described above.

The image forming apparatus main body 10 further includes an operation panel 13 having a function of receiving various types of operation from an operator and a function of displaying setting screen/operation screen, device status, warning, or the like. The operation panel 13 includes a liquid crystal display, a touch panel, and hardware buttons.

The image forming apparatus 3 includes a control substrate 20 that collectively controls operation of the image forming apparatus 3. The control substrate 20 includes a central processing unit (CPU), a memory, and a communication I/F, and executes programs, thereby serving as a control part 21, a storage 22, an inspection part 23, or the like.

The control part 21 of the image forming apparatus 3 controls operation related to main printing, a proper image group creation function, and a replacement function. In the main printing, the image forming apparatus main body 10 forms an image for each of pages related to a print job on a recording sheet and discharges the recording sheet carrying the created image to the stacker unit 7. Subsequently, the inline scanner unit 30 located between the image forming apparatus main body 10 and the stacker unit 7 optically reads each of the recording sheets being conveyed, and then, the inspection part 23 compares the image obtained by the reading and a proper image preliminarily stored in the storage 22 with each other to inspect normality/abnormality of the output product.

The proper image group creation function includes a function of forming an image on a recording sheet by the image forming apparatus main body 10 for each of pages related to the designated print job and discharging the recording sheet carrying the image to the stacker unit 7. The proper image group creation function also includes a function of optically reading each of the recording sheets by the inline scanner unit 30 and storing the image obtained by the reading as a proper image into the storage 22. In a case where a print job forms one set including a plurality of pages, the proper image is stored as a proper image group including the plurality of pages forming one set (for example, integrated into one file) in the storage 22.

The replacement function is a function of replacing a proper image of a portion of the pages included in a proper image group. Specifically, another proper image is newly obtained and this new image replaces a corresponding proper image in the proper image group, for a designated page alone out of the print job. More specifically, an image is formed on the recording sheet for a designated page by the image forming apparatus main body 10 and then, this recording sheet carrying the image is discharged to the stacker unit 7. Along with this operation, each of the recording sheets is optically read by the inline scanner unit 30 in the middle so as to obtain a proper image for replacement. Subsequently, the obtained proper image for replacement replaces the proper image of the corresponding page in the proper image group stored in the storage 22. Note that printing by the proper image group creation function will also be referred to as confirmation printing, and the printing by the replacement function will also be referred to as replacement printing.

The image forming apparatus 3 guides the user to replacement printing after execution of confirmation printing. Here, after execution (either interruption or completion) of confirmation printing, an operation screen for guiding to replacement printing is displayed. The guidance may also be performed by voice.

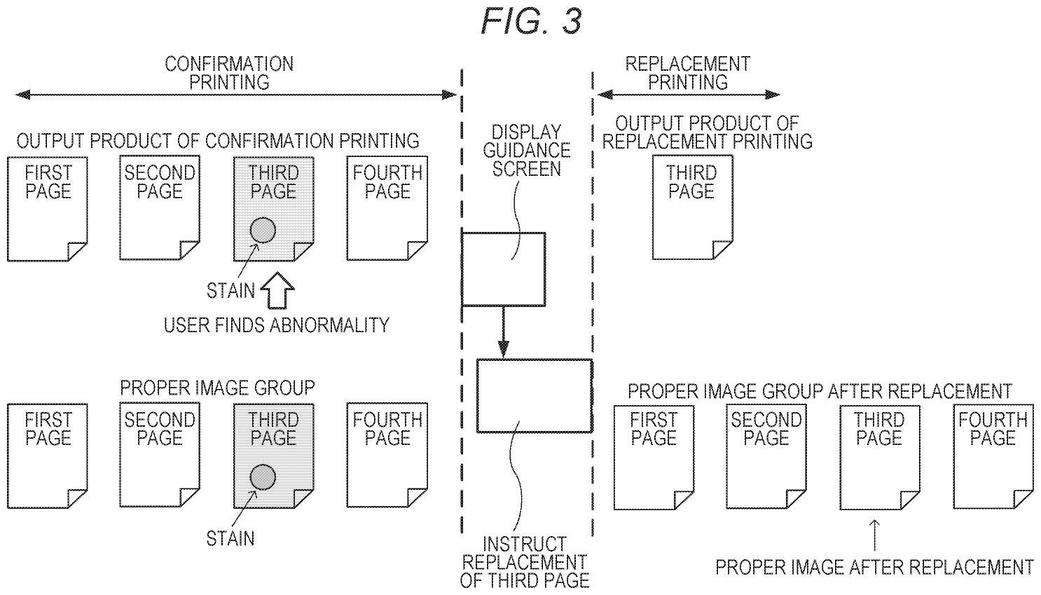

FIG. 3 is a view illustrating a case where a proper image of a portion (third page) of a proper image group created by confirmation printing is replaced by replacement printing. In this example, one copy of the print job includes four pages. In confirmation printing, each of pages of the print job is output in print, while a proper image group including proper images of these pages is generated and stored.

During confirmation printing, the user visually checks an output product of each of the pages and judges its normality/abnormality. In this example, the user finds an abnormality of stain on the third page but completes confirmation printing without interruption.

After completion of confirmation printing for four pages, the image forming apparatus 3 displays, on the operation panel 13, a predetermined operation screen for guiding the user to replacement printing. In accordance with the guidance, the user designates the third page with abnormality and instructs execution of replacement printing. In response to this instruction, the image forming apparatus 3 executes replacement printing of the third page and replaces the proper image of the third page among the stored proper image group with the proper image obtained by the replacement printing.

Next, an example of an operation screen for guiding a user to the replacement printing will be described.

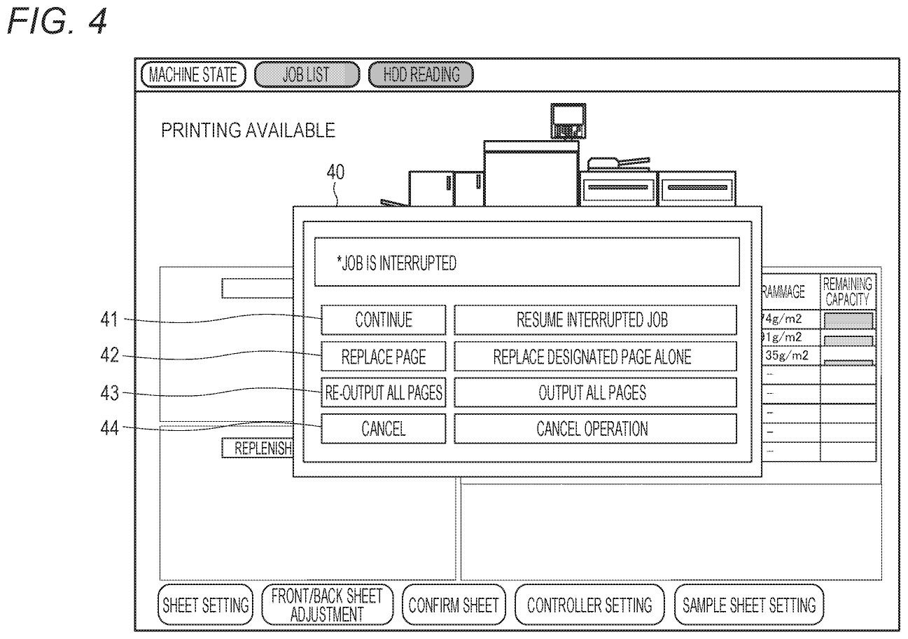

FIG. 4 illustrates an example of a first guidance screen 40 displayed on the operation panel 13 in a case where the confirmation printing is interrupted by receiving operation of the stop button from the user, or the like. In this example, the first guidance screen 40 is displayed as pop-up on a screen displaying various types of information regarding ongoing printing. Herein, the first guidance screen 40 displays a continue button 41, a page replace button 42, a re-output all pages button 43, and a cancel button 44.

When operation of selecting the continue button 41 is performed on the first guidance screen 40, the image forming apparatus 3 resumes the confirmation printing that has been interrupted. When operation of selecting the re-output all pages button 43 is performed on the first guidance screen 40, the image forming apparatus 3 discards all the proper images that have already been generated in the confirmation printing that has been interrupted, and restarts confirmation printing of the print job from the beginning. When operation of selecting the cancel button 44 is performed, the image forming apparatus 3 cancels the confirmation printing that has been interrupted, and at the same time, discards all the proper images already generated by this confirmation printing.

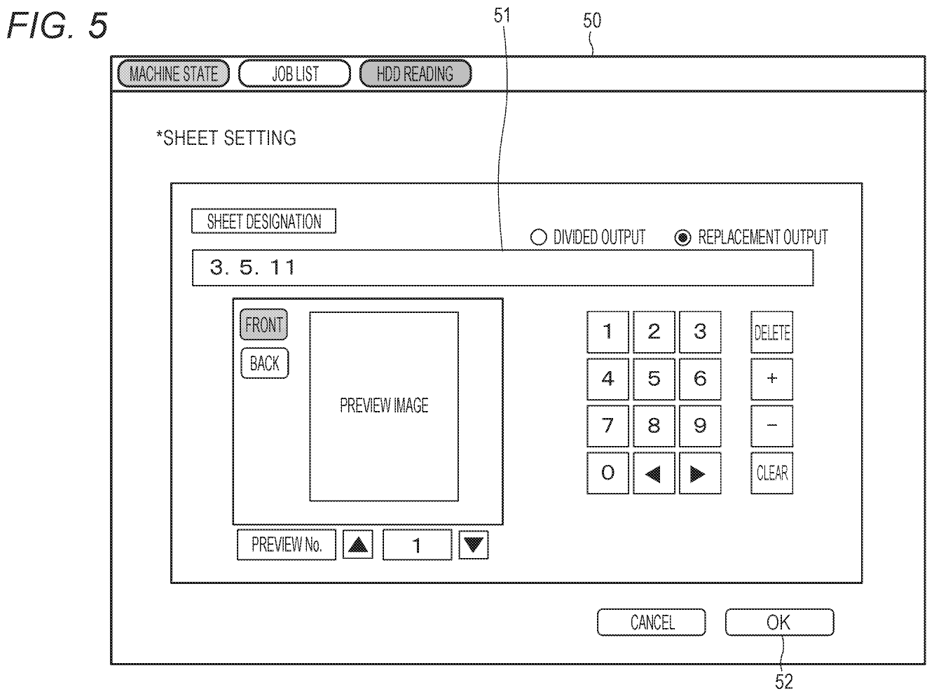

In a case where the image forming apparatus 3 has received operation of selecting the page replace button 42 on the first guidance screen 40, the image forming apparatus 3 switches a screen to be displayed on the operation panel 13 to a replacement page designation screen 50 illustrated in FIG. 5, and receives from the user a designation of the page to replace and an instruction of executing replacement printing. The replacement page designation screen 50 can be used to preview a previously stored proper image by designating a page. In addition, it is also possible to designate replacement page(s) individually by using numeric keys or the like. The designated replacement page is displayed in a page designation field 51.

In response to the operation of the OK button 52 on the replacement page designation screen 50, the image forming apparatus 3 executes replacement printing for the designated page.

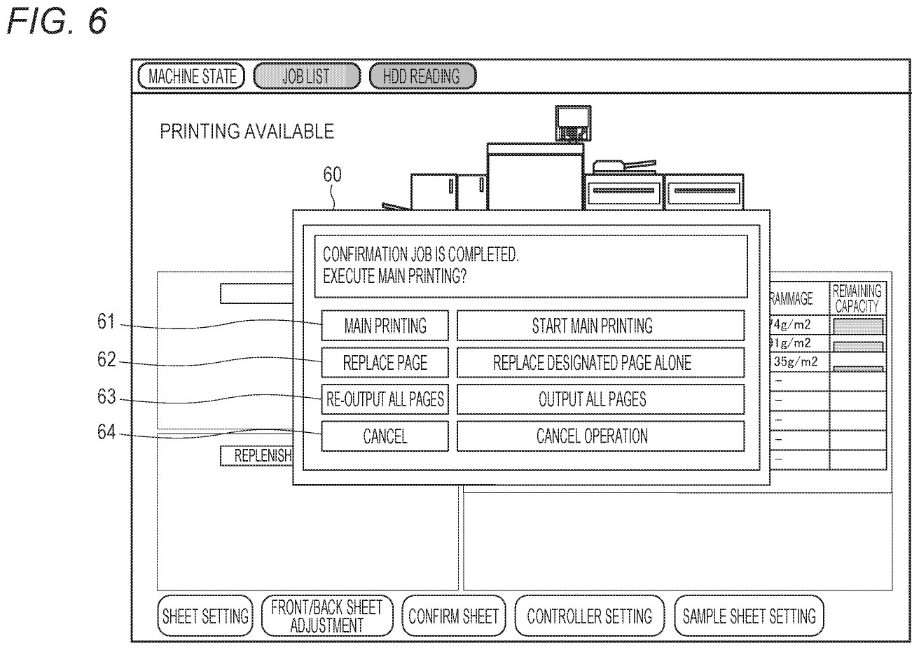

FIG. 6 illustrates an example of a second guidance screen 60 displayed on the operation panel 13 when the confirmation printing is completed up to the final page without receiving the operation of the stop button from the user. In this example, the second guidance screen 60 is displayed as pop-up on the screen during execution of printing. Herein, the second guidance screen 60 displays a main printing button 61, a page replace button 62, a re-output all pages button 63, a cancel button 64, or the like.

When operation of selecting the main printing button 61 is performed on the second guidance screen 60, the image forming apparatus 3 starts main printing for the print job that has undergone confirmation printing. When operation of selecting the re-output all pages button 63 is performed on the second guidance screen 60, the image forming apparatus 3 discards all the proper images that have already been generated in the completed confirmation printing, and restarts confirmation printing from the beginning. When operation of selecting the cancel button 64 is performed on the second guidance screen 60, the image forming apparatus 3 cancels the confirmation printing, and at the same time, discards all the proper images already generated by this confirmation printing.

In a case where the image forming apparatus 3 has received operation of selecting the page replace button 62 on the second guidance screen 60, the image forming apparatus 3 switches a screen to be displayed on the operation panel 13 to the replacement page designation screen 50 illustrated in FIG. 5, and receives a designation of the page to replace and an instruction of executing replacement printing.

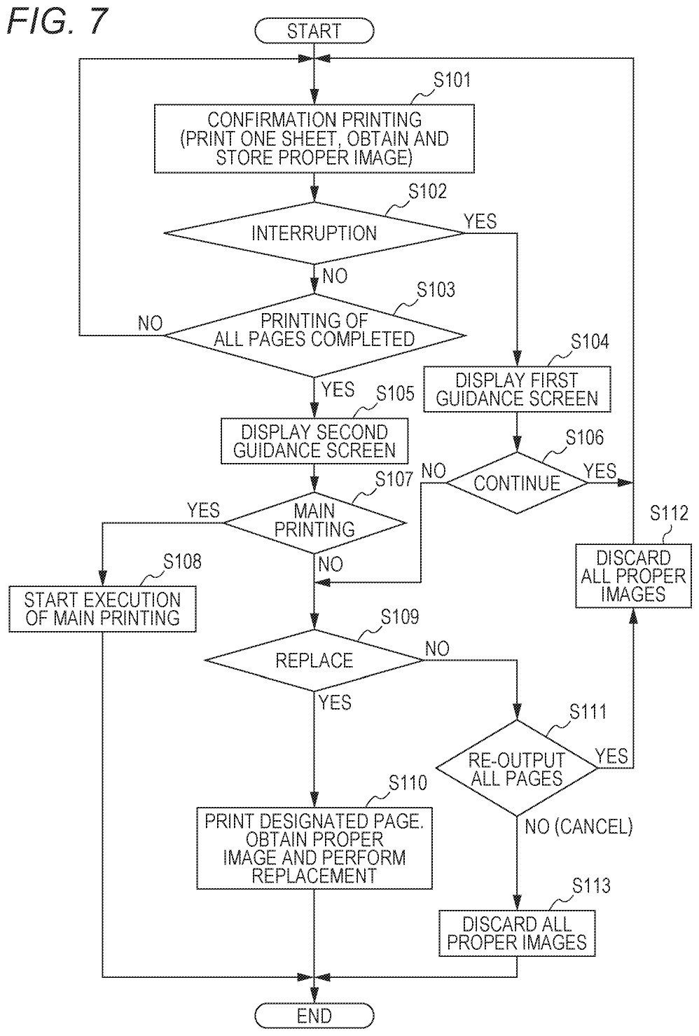

FIG. 7 is a flowchart illustrating processing performed by the image forming apparatus 3 after confirmation printing is started. The image forming apparatus 3 prints a page (two pages on the front and back sides in the case of duplex printing) to be printed on the next recording sheet by confirmation printing of the designated print job. At the same time, the image forming apparatus 3 uses the inline scanner unit 30 to read the page printed on the recording sheet and obtains a proper image during conveyance of the recording sheet, and adds the obtained proper image to the proper image group related to the confirmation printing, and then stores the obtained image in the storage 22 (step S101). The image forming apparatus 3 repeats the processing of step S101 until confirmation printing is interrupted or printing of all pages are completed (step S102; No, step S103; No).

In a case where confirmation printing is interrupted due to the operation of the stop button or the like (step S102; Yes), the image forming apparatus 3 displays the first guidance screen 40 illustrated in FIG. 4 on the operation panel 13 (step S104) and guides the user to replacement printing. In contrast, in a case where the confirmation printing has completed for all the pages (step S103; Yes), the image forming apparatus 3 displays the second guidance screen 60 illustrated in FIG. 6 on the operation panel 13 (step S105) and guides the user to replacement printing.

In a case where the operation of selecting the continue button 41 has been received on the first guidance screen 40 (step S106; Yes), the processing returns to step S101 to continue the confirmation printing. In a case where the operation of selecting the main printing button 61 has been received on the second guidance screen 60 (step S107; Yes), the main printing of the print job related to the confirmation priming is executed (step S108), and the present processing is finished.

When the operation of selecting the page replace buttons 42 or 62 has been received on the first guidance screen 40 or the second guidance screen 60 respectively (step S109; Yes), the screen is shifted to the replacement page designation screen 50 to receive designation of the page to be replaced, and then, replacement printing is executed for the designated page, replacement of the proper image is performed (step S110), and the present processing is finished.

In a case where the operation of selecting the re-output all pages button 43 or 63 is received on the first guidance screen 40 or the second guidance screen 60 respectively (step S111: Yes), all the proper images stored up to that point in the confirmation printing are discarded (step S112). The processing returns to step S101, and the confirmation printing is restarted from the first page.

In a case where operation of selecting the cancel button 44 or 64 on the first guidance screen 40 or the second guidance screen 60 respectively (step S111; No), all the proper images saved up to that point in the confirmation printing are discarded (step S113), and the present processing is finished.

Note that the first guidance screen 40 and the second guidance screen 60 may be displayed again after interruption or completion of the replacement printing. In a case where the replacement printing has been repeated a predetermined number of plurality of times, the image forming apparatus 3 guides the user to confirmation or alteration of image forming conditions. For example, it is possible to display a warning screen including a message such as “Replacement printing has been repeated. Please check the image forming conditions for error.” Alternatively, it is possible to display an operation button for shifting to a screen to alter the image forming condition, or it is even possible to automatically shift to a screen to alter the image forming conditions. With this configuration, it is possible to allow the user to find a cause of abnormality at an early stage, enabling suppression of further repetition of abnormality. Note that in order to avoid presentation of unnecessary and troublesome guidance to the user, the guidance by the user to alter the image forming conditions or the like is designed to be presented at a specific time when replacement printing is repeated a plurality of times.

In this manner, according to an embodiment of the present invention, in a case where the confirmation printing is interrupted or completed, it is possible to guide the user to the replacement printing to enable replacement of a portion of the proper images in the proper image group. Accordingly, there is no need to recreate the proper images of all the pages, making it possible to obtain a proper image group with normal pages in the entire group with a small additional work volume.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image forming part that forms an image on a recording material;
a reader that optically reads the recording material output from the image forming part; and
a hardware processor that
stores a proper image,
compares the image obtained by optically reading the recording material by using the reader and the proper image stored with each other to inspect normality abnormality of an output product, and
controls execution of a proper image group creation function including: firming an image of each of pages related to a print job on a recording material by the image forming part; optically reading, by the reader, the recording material output from the image forming part; and storing the image of each of the pages obtained by the reading as a proper image group related to the print job, and execution of a replacement function of replacing a proper image of a portion of pages included in the proper image group,
wherein the hardware processor guides a user to the replacement function after executing the proper image group creation function.

2. The image forming apparatus according to claim 1,
wherein the hardware processor performs the guidance by displaying an operation screen enabling selection of the replacement function.

3. The image forming apparatus according to claim 1,
wherein in a case where the execution of the proper image group creation function is interrupted, the hardware processor performs the guidance so as to enable selection of resumption and continuation of the execution of the proper image group creation function.

4. The image forming apparatus according to claim 1,
wherein in a case where the execution of the proper image group creation function is completed, the hardware processor performs the guidance so as to enable selection of execution of main printing related to the prim job.

5. The image forming apparatus according to claim 1,
wherein in a case where replacement of a page by the replacement function with respect to a proper image group related to one print job has been repeated a predetermined number of plurality of times, the hardware processor guides the user to confirmation or alteration of image forming conditions.
